(19) United States
(12) Patent Application Publication
(10) Pub. No.: US 2025/0128995 A1
(43) Pub. Date: Apr. 24, 2025

(54) METHOD OF USING/APPLYING A KERATIN HYDROLYSIS PEPTIDE SOLUTION TO IMPROVE THE FERTILIZER USAGE EFFICIENCY IN CORN

(71) Applicant: CH Biotech R&D Co., Ltd., Nantou City (TW)

(72) Inventors: Kai XIA, Nantou (TW); Ya-Wen HUANG, Taichung City (TW); Gui-Jun LI, Taichung (TW)

(73) Assignee: CH Biotech R&D Co., Ltd., Nantou City (TW)

(21) Appl. No.: 18/418,259

(22) Filed: Jan. 20, 2024

(30) Foreign Application Priority Data
Oct. 20, 2023 (TW) 112140295

(51) Int. Cl. C05G 3/00; C05F 11/00

(52) U.S. Cl. CPC C05G 3/00; C05F 11/00

(57) ABSTRACT

Present invention teaches the method of using a keratin hydrolysis peptide (“KHP”) solution to improve the efficacy of fertilizer usage and absorption by corn crops. By selectively choosing specific weights of feathers and water, and treating the mixture to a high-temperature high-pressure hydrolysis process, the resulting solution is confirmed to contain at least 253 peptides and then infused to the soil in which the corn crops show better growth and development despite fertilizers use may be reduced. Optionally, the KHP solution can be diluted by water, as disclosed in the specification, for applying to the soil around the corn crops.

### PRIORITY CLAIM TO FOREIGN APPLICATION

Applicant hereby makes priority claim to a Taiwan application, number 112140295, having the Taiwan filing date of Oct. 10, 2023.

### BACKGROUND OF THE INVENTION

Present invention disclosed and claimed the method and application of a keratin hydrolysis peptide (“KHP”) solution for improving the fertilizer utilization and absorption by corn crops by using the thermally hydrolyzed feather keratin peptide solution to the soil when the corn seeds are sowed.

With the application of the KHP solution as disclosed herein, the amount of fertilizer used can be reduced while the root growth and above-ground biomass of corn seedlings are improved.

The KHP solution is made by a hydrolysis process using feathers and water, with one version of the solution using feathers only, via a high-temperature and high-pressure process, resulting in a solution that has many beneficial applications in the fields of horticulture, agriculture and potentially other farming businesses.

Hydrolyzed keratin has long been used to strengthen hairs, reduce hair splitting and breakage. Other beneficial uses include skin moisturization and wound healing.

Hydrolyzed keratin solution has also been used to help to boost the production of certain plants and crops. Keratin hydrolysate has also been known to function as a biofertilizer, boosting essential nutrients for plant growth.

The inventors of present application found, by research and experiment, that certain method of keratin hydrolysis and the application may lead to improving the efficacy of fertilizer usage and absorption by corn crops.

Some type of chemical process is known to be used to break down the large protein molecule of the hydrolyzed keratin in order to reach a form applicable for the potential beneficial uses. In recent years, however, the chemical process is no longer favored, due to the potential negative impact on the environment.

The corn crops originated from America, primarily in the tropical regions, with good adaptability to different weather patterns and good for growing in warm, moist areas with ample sun lights. The short growth period of the corn plants makes them good for all-season planting and harvesting.

Among the three (3) primary nutrients (NPK: Nitrogen, Phosphorus, and Potassium) needed by most plants, Nitrogen plays the key role in the growth of the corn crops.

Proper use of Nitrogen-based nutrient, as base fertilizer at sowing stage, will help with the growth of corn crops at their seedling and early stages. In the early fruiting stage, proper use of Nitrogen-based fertilizer generally leads to increased production yield at harvest time.

The use of fertilizers, especially Nitrogen-based fertilizers, in fact has become overused over the past few decades. People have come to the realization that they need to find ways to cut back the use of fertilizers, while still are able to maintain the efficient growth and production of corn crops.

One way to achieve the goal is by, as the inventors of this application did, using a KHP solution that can be mixed to soil with fertilizer sparingly added, thus improving the fertilizer intake and absorption by the corn crops with healthier growth and development.

### SUMMARY OF THE INVENTION

The keratin solution is primarily based upon feather, which contains 85-91% keratin, 13-15% organic nitrogen, 1.6-2% organic sulfur, as well as other materials. The high keratin content has drawn many prior researches that work to break down, by enzyme, chemical agents, or fermentation process, into peptides, amino acids and other smaller molecules that can be used for animal feeds, plant fertilizers, and cultivation bases.

Around 2019, Nurdiawati, et al, came up with a hydrolysis process, by the mixture of a-amylase and protease to hydrolyze feather waste, resulting in a mixture of amino acids, fatty acids, and sugars. Nurdiawati experimented and adopted certain specific high-temperature and high-pressure setting in the hydrolysis process and discovered that the resulting solution, when mixed with some potassium and other minerals, can boost the growth of Pogostemon cablin and Vigna radiata, as reported in International Journal of Recycling or Organic Waste in Agriculture (8:221-232, 2019).

The inventors of present application selected different feather and water compositions and performed the hydrolysis at higher temperature and higher pressure setting, and obtained a different keratin hydrolysis peptide (“KHP”) solution that can be used on different crops/plants, including the corn crops that are grown with normal application of fertilizer, thus boosting the intake/absorption of the fertilizers.

The first embodiment of present invention uses a mixture of water and feathers (water content 50%) at the weight ratio of 3:2 (specific weight of 66 kg of feathers and 44 kg of water) and subject the mixture to a thermal hydrolysis process (80 minutes) to create a solution, resulting in the solution having molecular mass of 593.3-3,508.9 Dalton and containing at least 253 peptides as confirmed by using a mass spectrometer.

The inventors used the spectrometer Dionex UltiMate 3000 UPLC to separate the peptides; an analysis is done via Thermo Orbitrap Fushion Lumos Tribrid Orbitrap mass spectrometry to identify the peptides, which are then subsequently confirmed by looking up the BIOPEP-UWM database.

The solution then is applied to the soil in which some fertilizers were already added in before the corn seeds are planted.

The solution can be diluted by water, at 100 to 500 ratio by volume, and then applied to the soil in which the corn seeds are planted.

### BRIEF DESCRIPTION OF DRAWINGS

The accompanying drawings, figures and tables, which are incorporated in and constitute a part of this specification, illustrate and exemplify the preferred embodiments of the invention. Together with the description, serve to explain the principles of the invention.

Table I shows the at least 253 peptides and its annotated sequences for the solution generated in accordance with the disclosure of this application.

FIG. 1A shows the root system images, photographed after the dirt was cleaned off, among the check groups and the KHP solution groups, at 100% fertilization application and 50% fertilization application.

FIG. 1B shows the root system dry weights, after the dirt was cleaned off, among the four groups.

FIG. 2A shows the dry weight of the above-ground portions among the four groups.

FIG. 2B shows the stem width of the above-ground portion among the four groups.

FIG. 3 shows the leaf surface area comparisons among the four groups.

### DETAILED DESCRIPTION OF THE INVENTION

The keratin hydrolysis peptide (“KHP”) solution of present invention, as a first specific embodiment, is made by a high-temperature and high-pressure process to treat a mixture of water and feathers where the weight ratio whereby the weight ratio of feathers and water is set at 3:2. In the disclosure below, the specific weight of 66 kg feathers and 44 kg water will be used.

The hydrolysis process takes the steps of:
a. Preparing the KHP solution by mixing 66 kg of feathers whose content is 50% water with 44 kg of water in a sealed container;
b. hydrolyzing the mixture in the container with a temperature and pressure setting of 195° C. and 16 kg/cm² for a duration of 40 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm;

The confirmation of some of the 253 peptides is further done by referencing the BIOPEP-UWM database.

The solution can then be applied to the soil in which the corn seeds are planted.

The method of using a keratin hydrolysis peptide (KHP) solution stated above further causes the solution to be diluted with water by volume at the ratio of 1:100-500 for applying to the soil in which the corn seeds are planted.

The KHP solution can be made by another 2 sets of parameters shown herein:

| | | Water | | | | | | |
|---|---|---|---|---|---|---|---|---|
| | | Content | | | | | | |
| Feather | Water | in | | | | Product | | |
| Weight | Weight | Feathers | Presure | Temp | Time | Weight | Mass | Concentr. |
| (kg) | (kg) | % | (kg/cm²) | (° C.) | (min) | (kg) | (Dalton) | (ppm) |
| 70 | 0 | 46% | 13 | 180 | 40 | 131.65 | 705.9-3194.7 | 381250 |
| 50 | 40 | 50% | 12 | 185 | 80 | 136.66 | 593.3~3508.9 | 301500 |

To test the effectiveness of the KHP solution made by the steps disclosed herein, the inventors chose the first embodiment (having 66 kg feathers and 44 kg water) solution to conduct the field tests as further described herein. The first embodiment solution will be referred to as the KHP solution.

The field tests consist of four (4) groups of corn seeds planted into normal seeding pots where the soil is suitably mixed with regular Nitrogen-based fertilizer (TaiFei-43), with the growth condition of day time temperature 25° C., night time temperature 23° C.; day light hours of 16 and night time hours of 8. The day time light strength is 27000 lux. Each group has 3 pots for repeating the same tests and measurements.

The 4 groups are referred to as CK-1, CK-2, KHP-1, and KHP-2. The application of the fertilizer and KHP solution is noted below (125× denotes that the solution is diluted with water by volume at 1:125):

CK-1 group: the soil is infused with 0.15 g fertilizer, given 50 ml water; this is the 50% fertilized group.

CK-2 group: the soil is infused with 0.3 g fertilizer, given 50 ml water; this is the 100% fertilized group.

KHP-1 group: the soil is infused with 0.15 g fertilizer, given 50 ml water with KHP solution of 0.4 ml; this is the 50% fertilized group.

KHP-2 group: the soil is infused with 0.3 g fertilizer, given 50 ml water with KHP solution of 0.4 ml; this is the 100% fertilizer group.

The chart below summarized the fertilizer and the KHP solution usage:

| | | Fertilizer | KHP solution | |
|---|---|---|---|---|
| | | amount | added | Infused volume |
| | Fertilization | (g/pot) | (ml/pot) | (ml/pot) |
| CK-1 | 50% | 0.15 | 0 | Water 50 ml |
| KHP-1 | fertilized | | 0.4 | Water 50 ml |
| | | | | (KHP solution |
| | | | | diluted 125×) |
| CK-2 | 100% | 0.3 | 0 | Water 50 ml |
| KHP-2 | fertilized | | 0.4 | Water 50 ml |
| | | | | KHP solution |
| | | | | diluted 125×) |

On the 13^{th} day after the corn seeds were planted, the young plants from all the 4 groups are then removed from the pots, cleaned off the dirt/soil from the roots and the above-ground portion for taking different measurements as stated below.

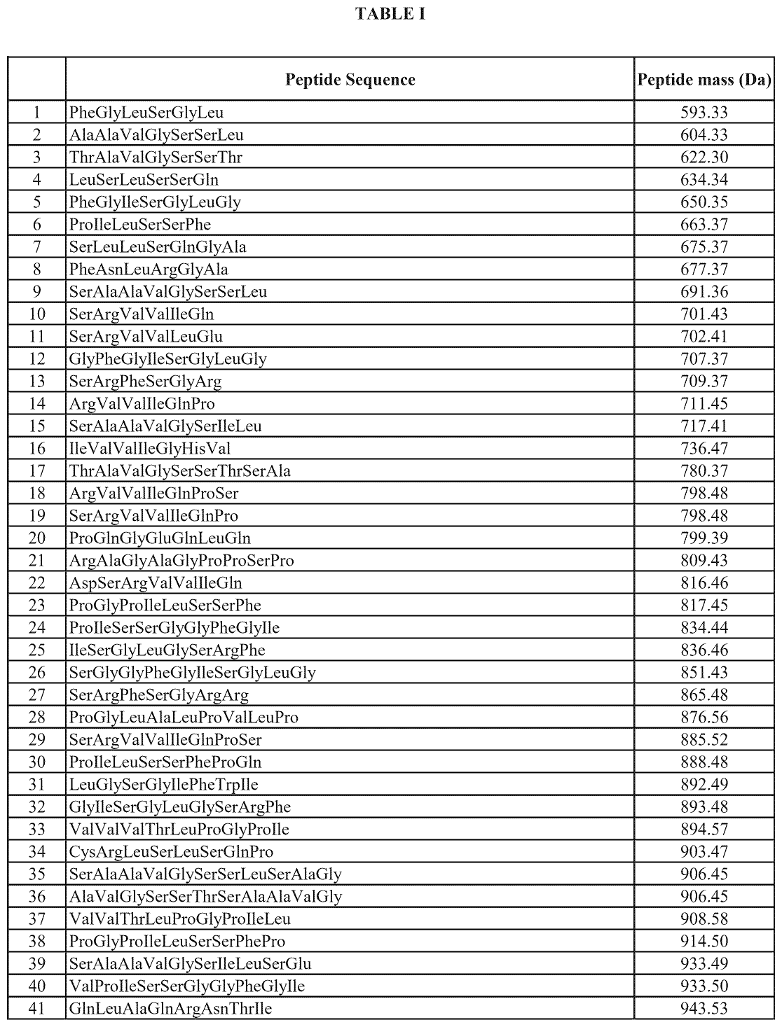

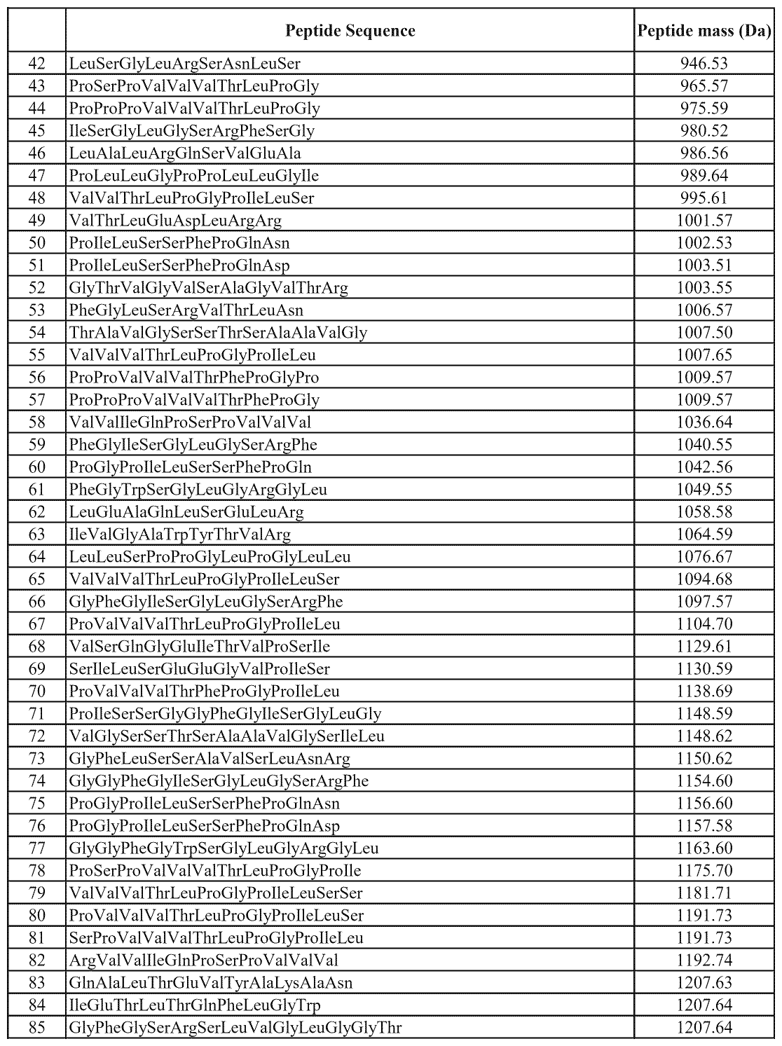

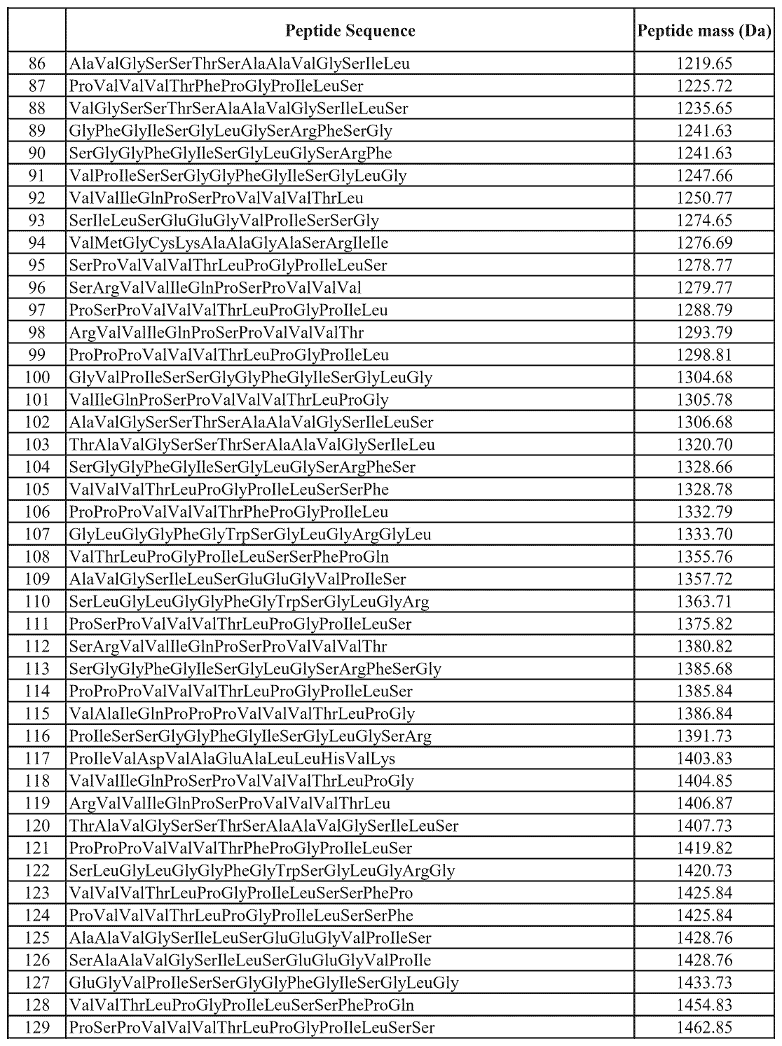

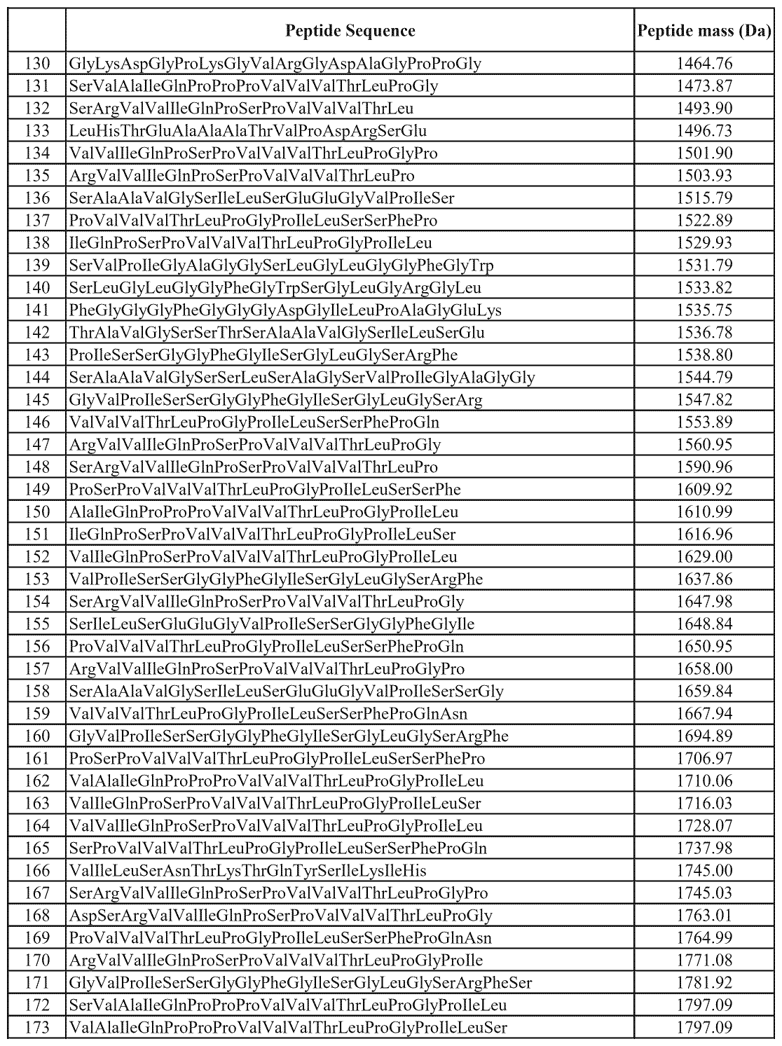

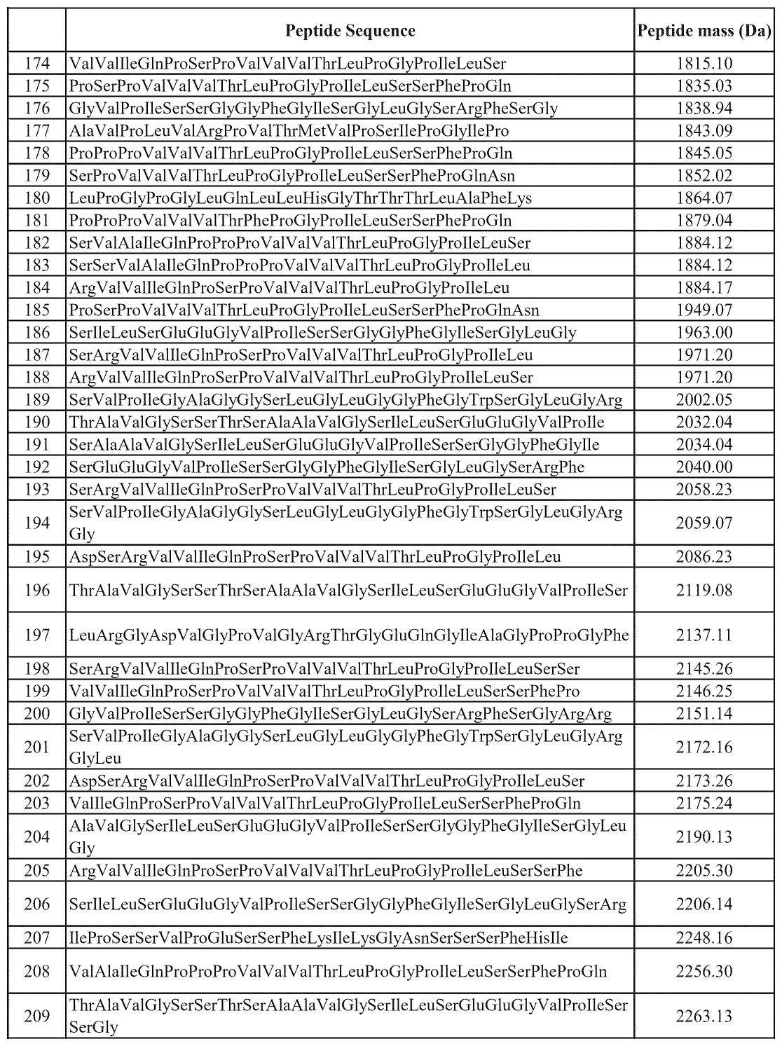

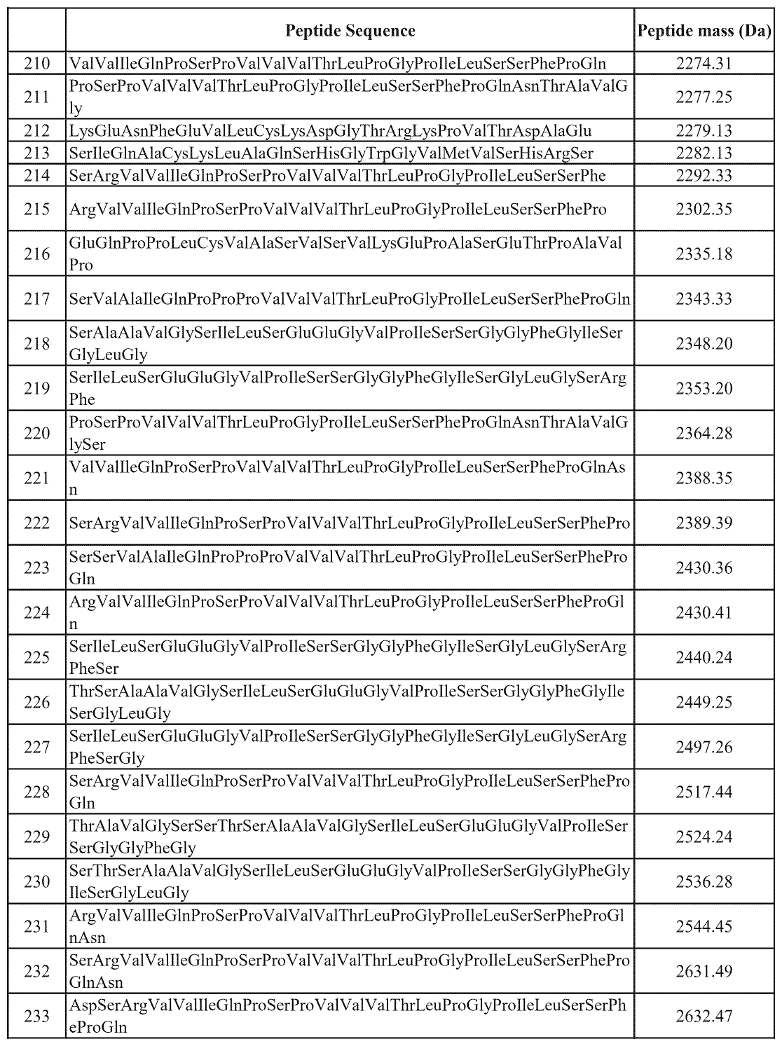

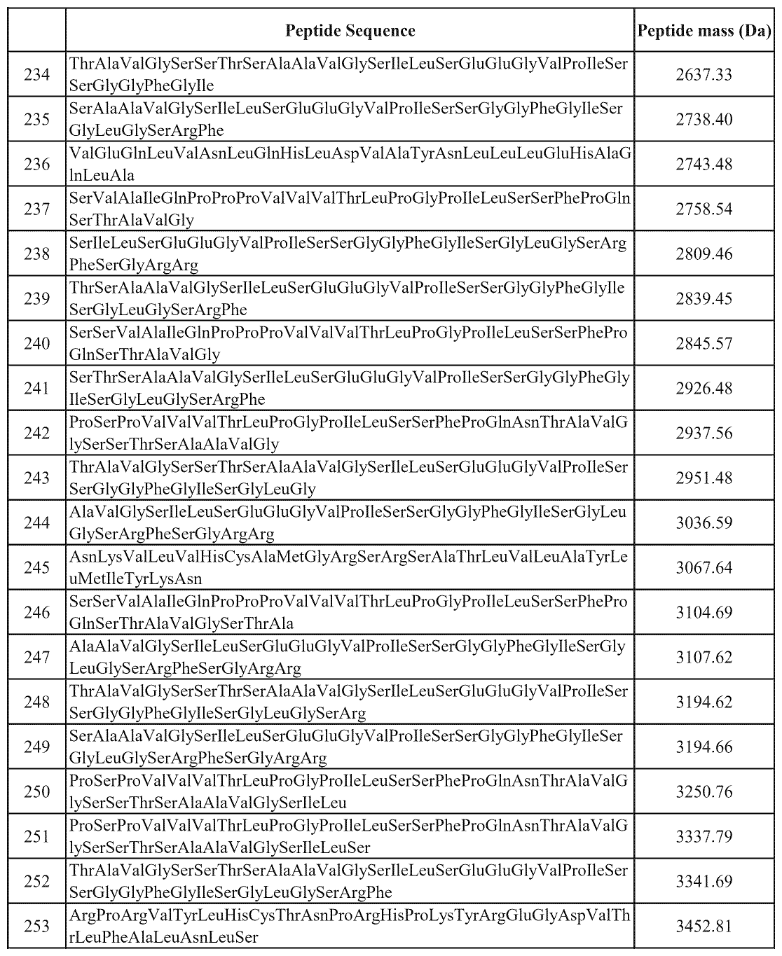

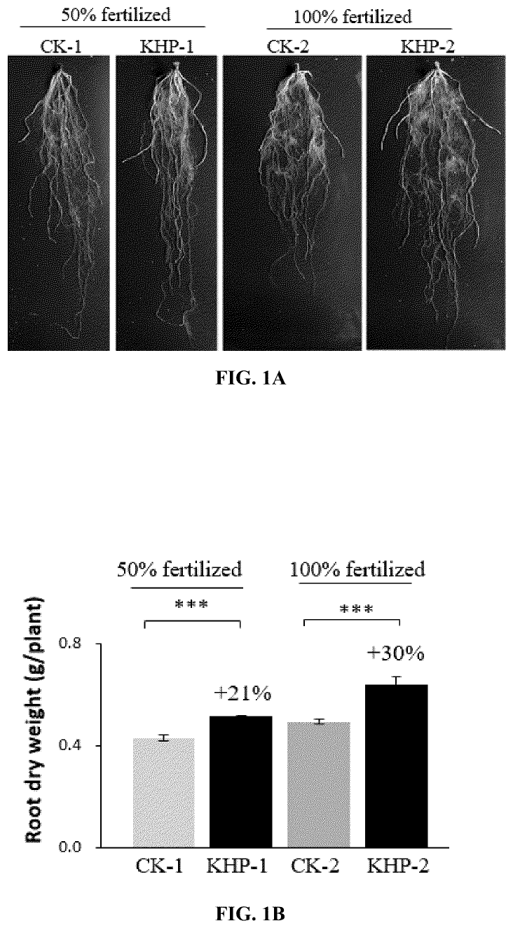

For the root growth's measurements, the dirt/soil was cleaned away, placed in a heating chamber to dry up and then weighed on a digital scale (AP224X, Shimadazu). The average figures (from the 3 repetitive pots) are shown in FIGS. 1A and 1B.

FIG. 1A shows the root systems' growth difference among the four (groups). As can be seen in the photographed images, the two KHP groups' root growth is substantially better than the corresponding check groups.

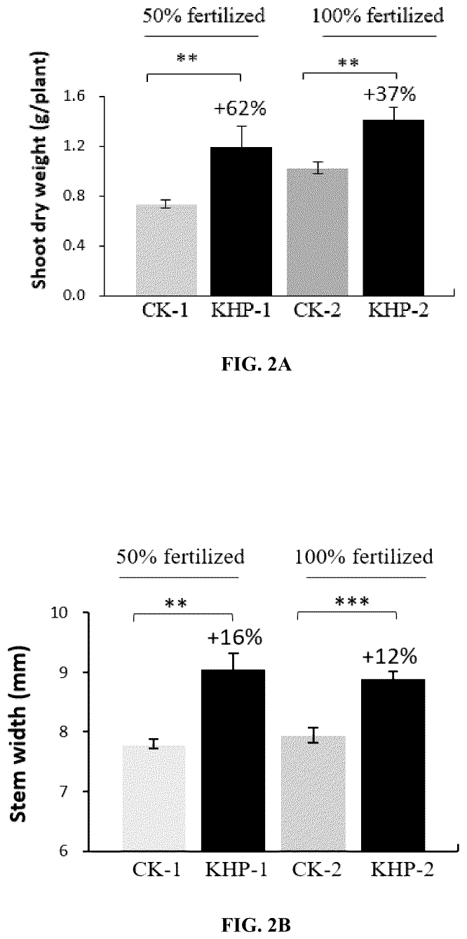

For the above-ground biomass comparison, the dry weights are compared and the main stem widths are measured. The results are noted in FIGS. 2A and 2B. Similar to the results in FIGS. 1A and 1B, the corn crops' growth, as aided by the fertilizer, shows better result when infused with KHP solution with fertilization at 100% or 50% level.

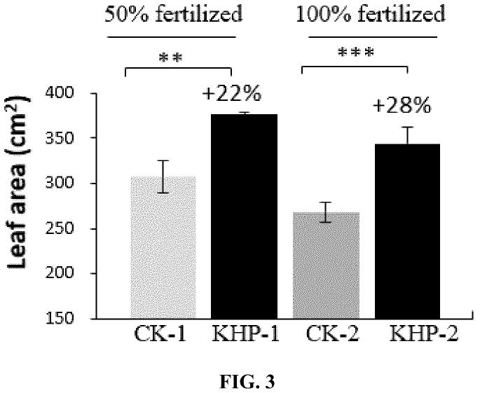

Lastly, the same number of fully matured leaves are taken from each of the 4 groups; using a leaf analyzer system (WinFOLIA Pro LA 2400, Regent Instruments) to measure the total leaf area. The results are noted in FIG. 3. Similar to the results in FIGS. 1A, 1B, 2A and 2B, the 2 KHP groups show better growth condition than the check groups where the groups are aided by the same amount of fertilizers (both 50% and 100% fertilization settings).

As has been proven by the field tests, and the scientific analysis/measurement done by the inventors, the method of creating the KHP solution and the method of application to corn crops will help with improving the fertilizer efficacy and, consequently, reducing the fertilizer usage overall.

While the disclosure herein gave limited teachings and embodiment examples, it should be noted that the description and disclosure made herein illustrated the preferred embodiments of the invention and are not meant to limit the scope of the applicant's rights. Variations and alterations may be employed for yet additional embodiments without departing from the scope of the invention herein.

1. A method of using a keratin hydrolysis peptide (KHP) solution to increase the fertilizer use efficiency for corn plants, comprising the steps of:
a. Preparing the KHP solution by mixing 66 kg of feathers whose content is 50% water and 44 kg of water in a sealed container;
b. hydrolyzing the mixture in the container with a temperature and pressure setting of 195° C. and 16 kg/cm² for a duration of 40 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. applying the solution to the fertilized soil in which the corn seeds are planted.

2. The method of using a keratin hydrolysis peptide (KHP) solution of claim 1 where the solution is diluted with water by volume at the ratio of 1:100-500 for applying to the fertilized soil in which the corn seeds are planted.

3. The method of using a keratin hydrolysis peptide (KHP) solution of claim 1 where the solution is diluted with water by volume at the ratio of 1:125 for applying to the soil in which the corn seeds are planted.
